(19) United States
(12) Patent Application Publication
(10) Pub. No.: US 2020/0283218 A1
(43) Pub. Date: Sep. 10, 2020

(54) POUCHED UNIT AND METHOD OF USING SAID POUCHED UNIT

(71) Applicant: EME Engel Machinefabriek En Engineering B.V., Zaandam (NL)

(72) Inventor: Arie BOOD, Zaandam (NL)

(21) Appl. No.: 16/648,100

(22) PCT Filed: Sep. 19, 2018
(86) PCT No.: PCT/NL2018/050617

§ 371 Date: Mar. 17, 2020

(30) Foreign Application Priority Data
Sep. 19, 2017 (NL) 2019573

(51) Int. Cl. B65D 81/32; B65D 65/46; C11D 17/04; B65D 75/52

(52) U.S. Cl. CPC B65D 81/3266; B65D 65/46; B65B 2230/02; B65D 75/527; B65B 2220/22; C11D 17/045

(57) ABSTRACT

A pouched unit comprising a dose of a substance which is enveloped by a main part of a pouch made from a water soluble material, wherein the pouch comprises a secondary part made from the water soluble material, the secondary part is attached to the main part via a weaker area of the water soluble material, which weaker area is configured to allow manual separation of the secondary part from the main part, and a message is provided on the secondary part.

### FIELD OF THE INVENTION

The invention relates to a pouched unit comprising a dose of a substance which is enveloped by a main part of a pouch made from a water soluble material. In practice, such a pouched unit is often used for detergents, like a laundry detergent.

### BACKGROUND OF THE INVENTION

The invention is based on the insight that there is a need to inform the user.

### SUMMARY OF THE INVENTION

The invention has the objective to provide an improved (or at least alternative) pouched unit. This objective is reached by a pouched unit comprising a dose of a substance which is enveloped by a main part of a pouch made from a water soluble material, wherein the pouch comprises a secondary part made from the water soluble material, the secondary part is attached to the main part via a weaker area of the water soluble material, which weaker area is configured to allow manual separation of the secondary part from the main part, and a message is provided on the secondary part.

The secondary part allows that a message can be added to pouched unit. The message may comprise user instructions for the user of the pouched unit. The weaker area allows that the additional water soluble material of the secondary part of the pouch can manually be removed before the main part of the pouch and its dose of substance is used. This way, a message can be provided to the user while preventing that the additional water soluble material of the secondary part negatively affects the use of the main part and its dose of substance.

In an embodiment of the pouched unit, the message comprises a text or a symbol.

In an embodiment of the pouched unit, the message is provided on the secondary part by a colourant.

In an embodiment of the pouched unit, the message is provided on the secondary part by a relief.

In an embodiment of the pouched unit, the pouch has a lower tensile strength at the weaker area when compared with the main part and the secondary part.

In an embodiment of the pouched unit, the secondary part extends away from the main part.

In an embodiment of the pouched unit, the substance in the main part of the pouch is a detergent material, such as a laundry detergent.

In an embodiment of the pouched unit, the water soluble material has been subjected to a weakening treatment at the weaker area.

In an embodiment of the pouched unit, the weaker area comprises one incision or multiple incisions in the water soluble material.

In an embodiment of the pouched unit, the pouch is only formed by the water soluble material.

In an embodiment of the pouched unit, the pouch is formed by at least two interconnected films of the water soluble material.

In an embodiment of the pouched unit, the main part comprises a main peripheral rim, the secondary part comprises a secondary peripheral rim, the at least two films are connected to each other at the main peripheral rim, the weaker area and the secondary peripheral rim, and the weaker area is located between the main peripheral rim and the secondary peripheral rim.

In an embodiment of the pouched unit, the main peripheral rim surrounds the substance and the secondary peripheral rim surrounds the message.

In an embodiment of the pouched unit, at least one recess is provided in the two interconnected films adjacent to the weaker area, and the recess extends between the main peripheral rim and the secondary peripheral rim.

In an embodiment of the pouched unit, a first recess and a second recess is provided in the two interconnected films adjacent to the weaker area, the first recess and the second recess extend between the main peripheral rim and the secondary peripheral rim, and the weaker area is located between the first recess and the second recess.

In an embodiment of the pouched unit, the weaker area is located between a main side part of the main peripheral rim and a secondary side part of the secondary peripheral rim, the main side part and the secondary side part extend in a side part direction, and the weaker area extends over a smaller distance in the side part direction than each of the main side part and the secondary side part.

The invention further relates to a method of using a pouched unit according to the invention. Said method comprises holding the main part of the pouch in one hand and holding the secondary part of the pouch in another hand, and manually separating the secondary part from the main part at the weaker area.

In an embodiment of the method, the substance in the main part is a laundry detergent and the method comprises;
placing laundry in a washing machine,
analysing the message of the secondary part,
placing the main part of the in the washing machine after the secondary part has been manually separated from the main part, and
disposing the secondary part.

### BRIEF DESCRIPTION

Embodiments of the pouched unit and the method according to the invention will be described by way of example only, with reference to the accompanying schematic drawings in which corresponding reference symbols indicate corresponding parts, and in which:

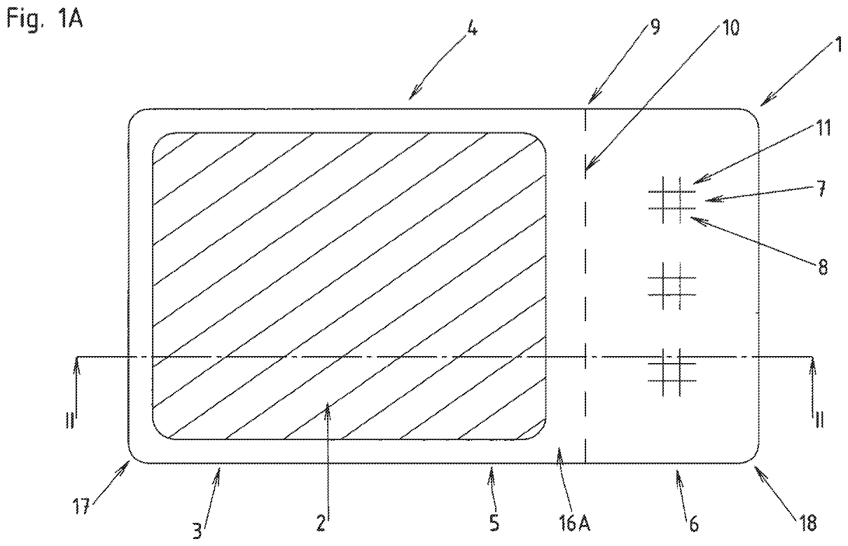

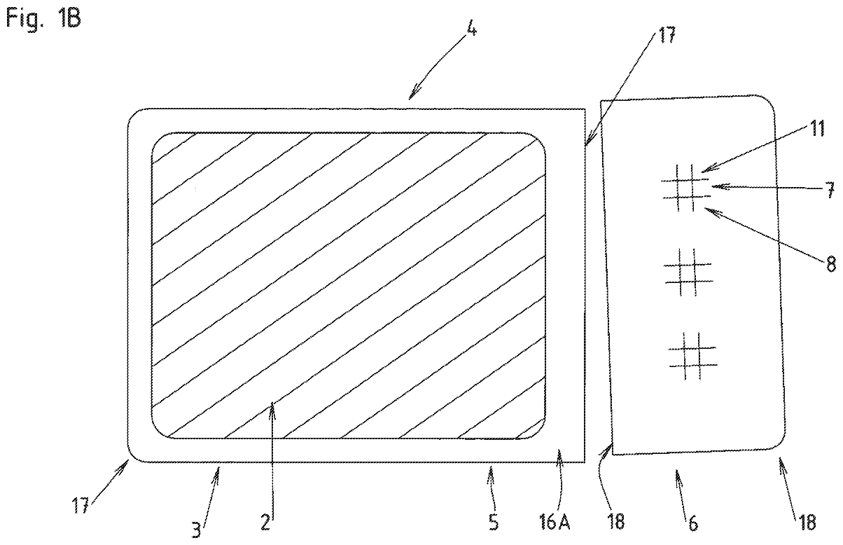

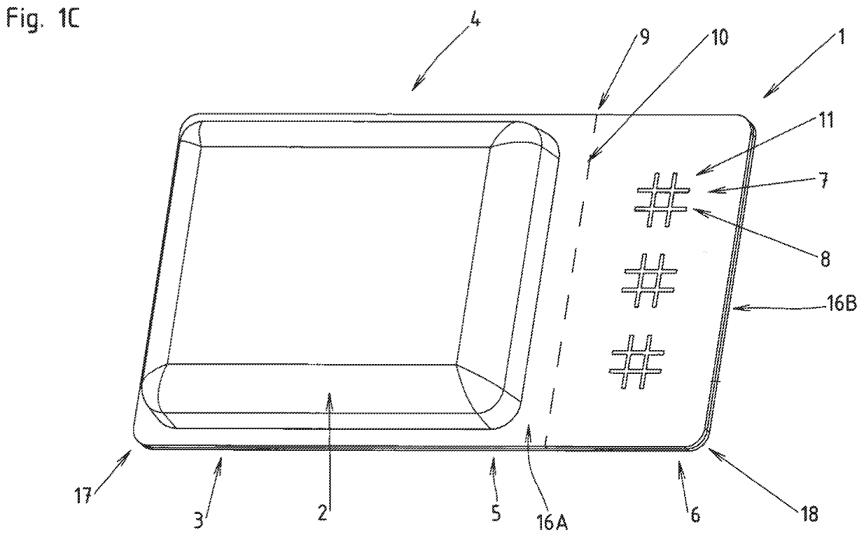

FIG. 1A schematically shows a front view of a first embodiment of the pouched unit according to the invention,

FIG. 1B schematically shows a front view of the pouched unit of FIG. 1A, wherein the main part and the secondary part have been manually separated,

FIG. 1C schematically shows a view in perspective of the pouched unit of FIG. 1A,

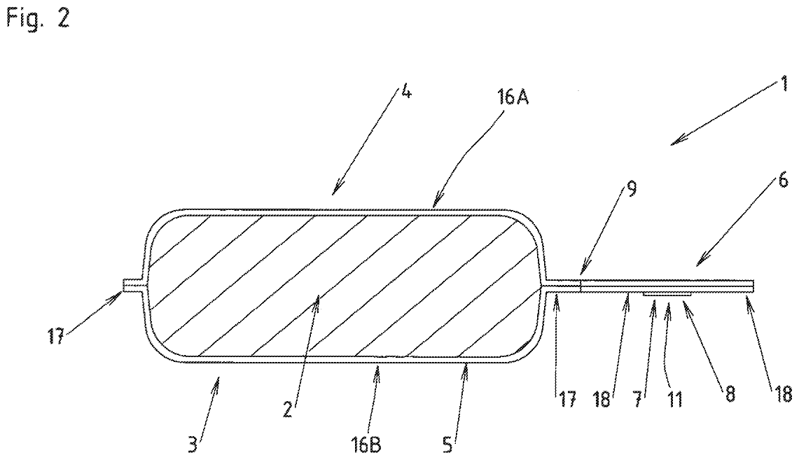

FIG. 2 schematically shows a view in cross section along line II-II of the pouched unit of FIG. 1A,

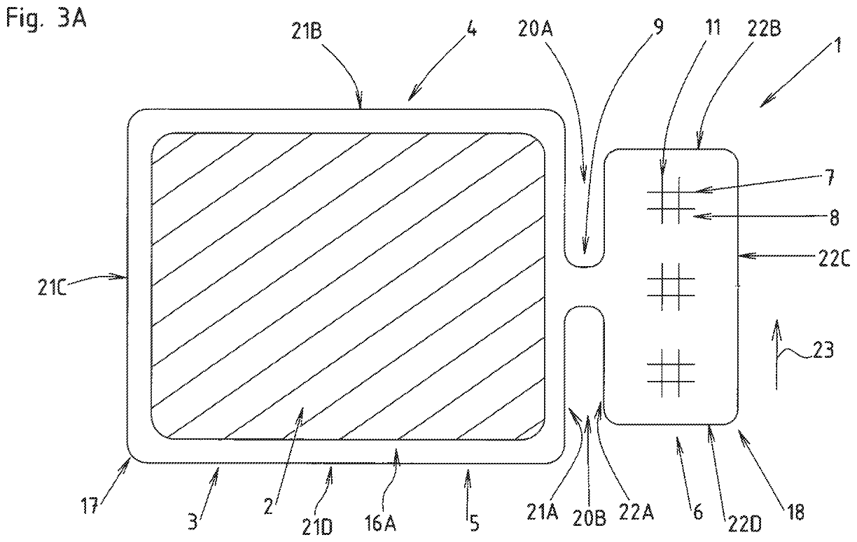

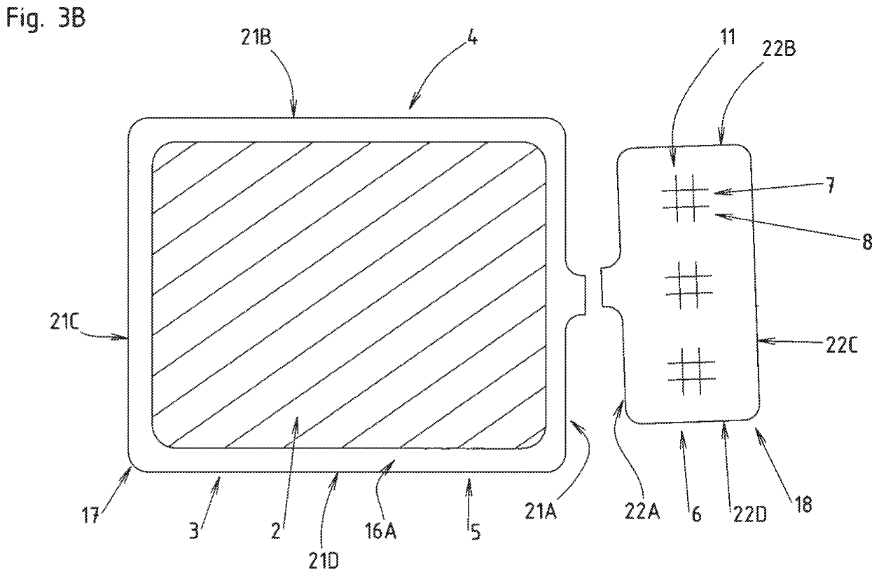

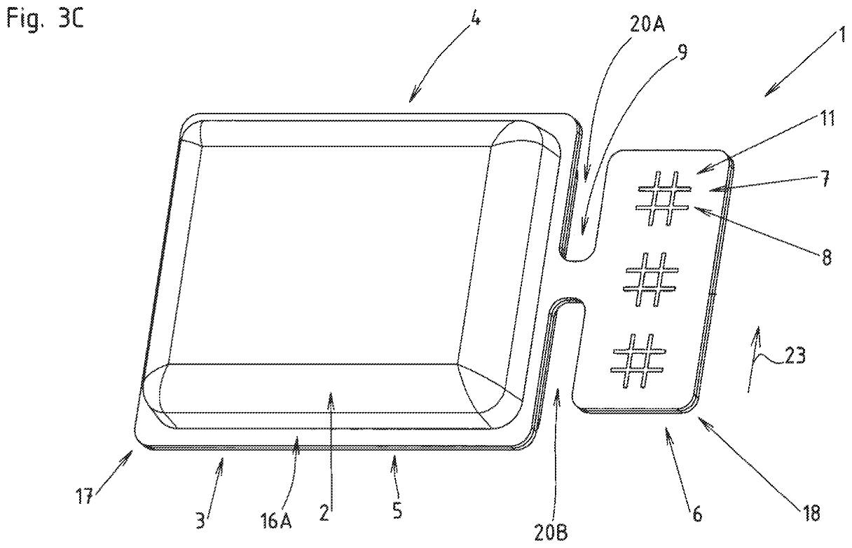

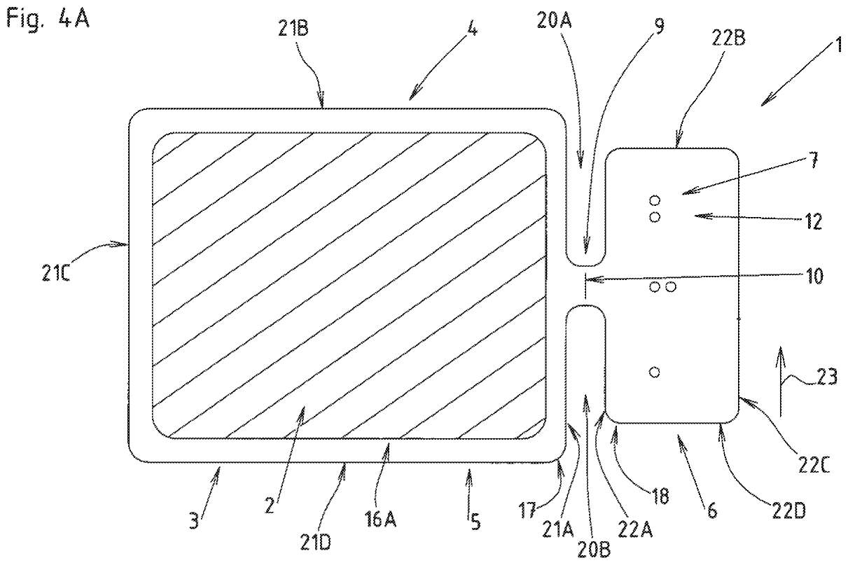

FIG. 3A schematically shows a front view in a second embodiment of the pouched unit according to the invention,

FIG. 3B schematically shows a front view of the pouched unit of FIG. 3A, wherein the main part and the secondary part have been manually separated,

FIG. 3C schematically shows a view in perspective of the pouched unit of FIG. 3A,

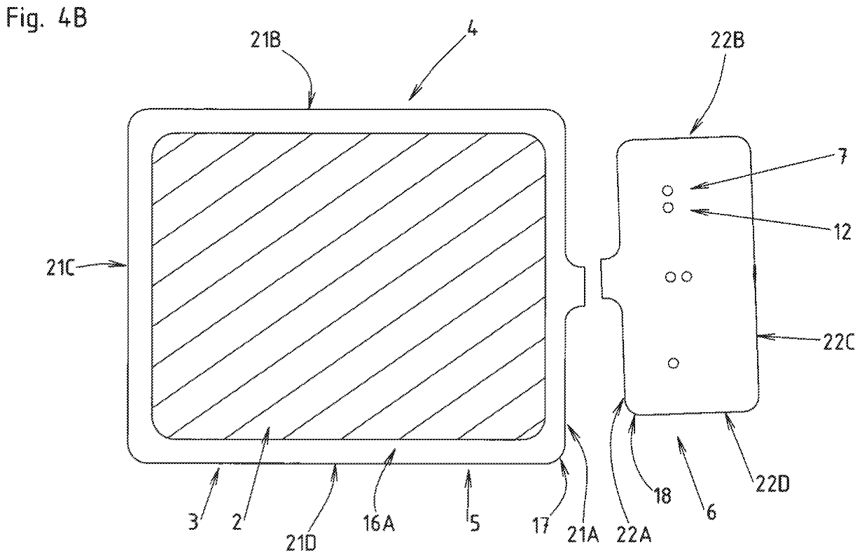

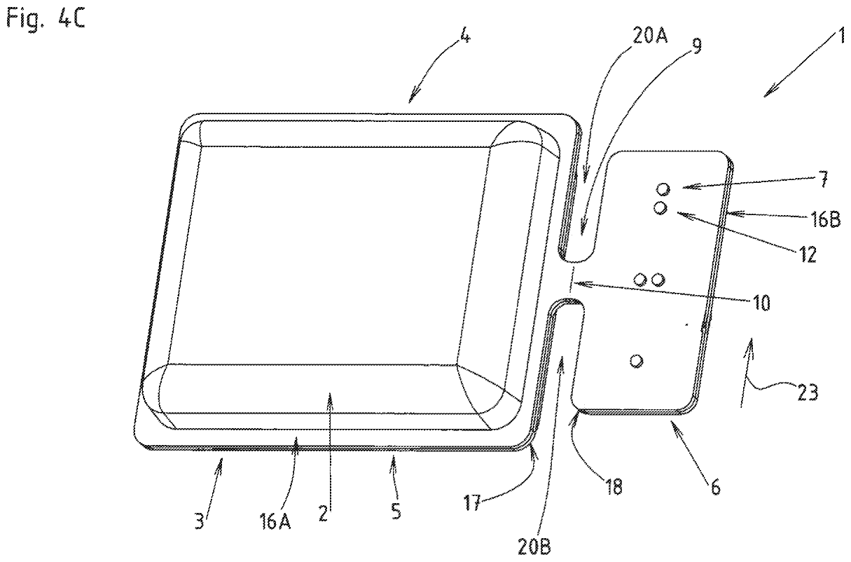

FIG. 4A schematically shows a front view in a third embodiment of the pouched unit according to the invention,

FIG. 4B schematically shows a front view of the pouched unit of FIG. 4A, wherein the main part and the secondary part have been manually separated, and

FIG. 4C schematically shows a view in perspective of the pouched unit of FIG. 4A.

The FIGS. 1A-C and 2 show a first embodiment of the pouched unit 1 according to the invention. The pouched unit 1 comprises a dose of a substance 2 which is enveloped by a main part 3 of a pouch 4 made from a water soluble material 5. The pouch 4 comprises a secondary part 6 made from the water soluble material 5. The secondary part 6 is attached to the main part 3 via a weaker area 9 of the water soluble material 5. The weaker area 9 is configured to allow manual separation of the secondary part 6 from the main part 3.

The secondary part 6 comprises a message 7 with user information for the user. The weaker area 9 allows that the additional water soluble material 5 of the secondary part 6 of the pouch 4 can manually be removed before the main part 3 of the pouch 4 and its dose of substance 2 is used. This way, the message 7 can be provided to the user while preventing that the additional water soluble material of the secondary part 6 negatively affects the use of the main part 3 and its dose of substance 2.

The pouch 4 has a lower tensile strength at the weaker area 9 when compared with the main part 3 and the secondary part 6. This facilitates the manually separation of the secondary part 6 from the main part 3.

The secondary part 6 extends away from the main part 3. This facilitates the addition of the message 7 to the secondary part 6.

The substance 2 in the main part 3 of the pouch 4 is a detergent material, more specifically a laundry detergent. The message 7 comprises user instructions for the user of the pouched unit 1. The message 7 may comprise different information, such a warning for toxic materials. The message 7 may comprise a text or a symbol 8. The message 7 is provided on the secondary part 6 by a colourant 11. The water soluble material 5 is transparent.

The water soluble material 5 is a polyvinyl alcohol (PVOH). Other types of water soluble materials may be used.

The water soluble material 5 has been subjected to a weakening treatment at the weaker area 9. The weaker area 9 comprises multiple incisions 10 in the water soluble material 5. In another example, the weaker area 9 comprises one incision 10 in the water soluble material 5.

The pouch 4 is only formed by the water soluble material 5. This means that the pouch 4 itself only contains the water soluble material 5. It is possible that another material is provided on the pouch, such as a colorant.

The pouch 4 is formed by two interconnected films 16A, 16B of the water soluble material 5. The two films 16A, 16B are transparent. In other examples, the water soluble material 5 is translucent, or opaque. The water soluble material 5 may coloured.

The main part 3 comprises a main peripheral rim 17. The secondary part 6 comprises a secondary peripheral rim 18. The at least two films 16A, 16B are connected to each other at the main peripheral rim 17, the weaker area 9 and the secondary peripheral rim 18. The weaker area 9 is located between the main peripheral rim 17 and the secondary peripheral rim 18. The main peripheral rim 17 surrounds the substance 2 and the secondary peripheral rim 18 surrounds the message 7.

The method of using the pouched unit 1 comprises holding the main part 3 of the pouch 4 in one hand and holding the secondary part 6 of the pouch 4 in another hand, and manually separating the secondary part 6 from the main part 3 at the weaker area 9. More specifically, the method comprises placing laundry in a washing machine, analysing the message 7 of the secondary part 6, placing the main part 3 of the in the washing machine after the secondary part 6 has been manually separated from the main part 3, and disposing the secondary part 6.

The FIGS. 3A-C show a second embodiment of the pouched unit 1 according to the invention. A first recess 20A and a second recess 20B is provided in the two interconnected films 16A, 16B adjacent to the weaker area 9. The first recess 20A and the second recess 20B extend between the main peripheral rim 17 and the secondary peripheral rim 18. The weaker area 9 is located between the first recess 20A and the second recess 20B.

In another example, only one recess is provided in the two interconnected films 16A, 16B adjacent to the weaker area 9, and the recess extends between the main peripheral rim 17 and the secondary peripheral rim 18.

The main peripheral rim 17 comprises a first main side part 21A, a second main side part 21B, a third main side part 21C, and a fourth main side part 21D. The secondary peripheral rim 18 comprises a first secondary side part 22A, a second secondary side part 22B, a third secondary side part 22C, and a fourth secondary side part 22D. The weaker area 9 is located between the first main side part 21A of the main peripheral rim 17 and the first secondary side part 22A of the secondary peripheral rim 18. The first main side part 21A and the first secondary side part 22A extend in a side part direction 23. The weaker area 9 extends over a smaller distance in the side part direction 23 than each of the first main side part 21A and the first secondary side part 22A.

The FIGS. 4A-C shows a third embodiment of the pouched unit 1 according to the invention. Also in this embodiment, the substance 2 comprises a detergent.

The message 7 is provided on the secondary part 6 by a relief 12. More specifically, the relief 12 is braille to inform people who are blind or visually impaired. In other examples, the relief 12 has the form of text or as symbol 8.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the pouched unit and the method without departing from the scope as defined in the claims.

1. A pouched unit comprising a dose of a substance which is enveloped by a main part of a pouch made from a water soluble material, wherein;
the pouch comprises a secondary part made from the water soluble material,
the secondary part is attached to the main part via a weaker area of the water soluble material, which weaker area is configured to allow manual separation of the secondary part from the main part, and
a message is provided on the secondary part.

2. The pouched unit according to claim 1, wherein the message comprises a text or a symbol.

3. The pouched unit according to claim 1, wherein the message is provided by a colourant.

4. The pouched unit according to claim 1, wherein the message is provided by a relief.

5. The pouched unit according to claim 1, wherein the pouch has a lower tensile strength at the weaker area when compared with the main part and the secondary part.

6. The pouched unit according to claim 1, wherein the secondary part extends away from the main part.

7. The pouched unit according to claim 1, wherein the substance in the main part of the pouch is a detergent material, such as a laundry detergent.

8. The pouched unit according to claim 1, wherein the water soluble material has been subjected to a weakening treatment at the weaker area.

9. The pouched unit according to claim 8, wherein the weaker area comprises one incision or multiple incisions in the water soluble material.

10. The pouched unit according to claim 1, wherein the pouch is only formed by the water soluble material.

11. The pouched unit according to claim 1, wherein the pouch is formed by at least two interconnected films of the water soluble material.

12. The pouched unit according to claim 11, wherein;
the main part comprises a main peripheral rim,
the secondary part comprises a secondary peripheral rim,
the at least two films are connected to each other at the main peripheral rim, the weaker area and the secondary peripheral rim, and
the weaker area is located between the main peripheral rim and the secondary peripheral rim.

13. The pouched unit according to claim 12, wherein
the main peripheral rim surrounds the substance and the secondary peripheral rim surrounds the message.

14. The pouched unit according to claim 12, wherein at least one recess is provided in the two interconnected films adjacent to the weaker area, and the recess extends between the main peripheral rim and the secondary peripheral rim.

15. The pouched unit according to claim 12, wherein a first recess and a second recess is provided in the two interconnected films adjacent to the weaker area, the first recess and the second recess extend between the main peripheral rim and the secondary peripheral rim, and the weaker area is located between the first recess and the second recess.

16. The pouched unit according to claim 12, wherein;
the weaker area is located between a main side part of the main peripheral rim and a secondary side part of the secondary peripheral rim,
the main side part and the secondary side part extend in a side part direction, and
the weaker area extends over a smaller distance in the side part direction than each of the main side part and the secondary side part.

17. A method of using a pouched unit comprising a dose of a substance which is enveloped by a main part of a pouch made from a water soluble material, wherein the pouch comprises a secondary part made from the water soluble material, the secondary part is attached to the main part via a weaker area of the water soluble material, which weaker area is configured to allow manual separation of the secondary part from the main part, and a message is provided on the secondary part, said method comprising;
holding the main part of the pouch in one hand and holding the secondary part of the pouch in another hand, and
manually separating the secondary part from the main part at the weaker area.

18. The method according to claim 17, wherein the substance in the main part is a laundry detergent and the method comprises;
placing laundry in a washing machine,
analysing the message of the secondary part,
placing the main part of the in the washing machine after the secondary part has been manually separated from the main part, and
disposing the secondary part.
